(19) United States
(12) Patent Application Publication
(10) Pub. No.: US 2009/0133722 A1
(43) Pub. Date: May 28, 2009

(54) APPARATUS AND METHOD FOR CLEANING A SUBSTRATE

(75) Inventors: Jeong-Deog KOH, Gyeonggi-do (KR); Young-Joo SHIN, Gyeonggi-do (KR); In-Seak HWANG, Gyeonggi-do (KR)

Correspondence Address: MARGER JOHNSON & MCCOLLOM, P.C., 210 SW MORRISON STREET, SUITE 400, PORTLAND, OR, 97204, US

(73) Assignee: Samsung Electronics Co., Ltd., Gyeonggi-do (KR)

(21) Appl. No.: 12/257,164

(22) Filed: Oct. 23, 2008

(30) Foreign Application Priority Data
Oct. 23, 2007 (KR) 10-2007-006720

(51) Int. Cl. B08B 7/04

(52) U.S. Cl. 134/63

(57) ABSTRACT

Provided is an apparatus for cleaning a substrate. The substrate cleaning apparatus includes a spin head for supporting the substrate, a first cleaning unit for cleaning the substrate by a polishing process, and a second cleaning unit for cleaning the substrate by injecting a treating solution. Initially, the polishing pad is in contact with the substrate to polish the substrate and then the polishing pad is removed from contact with the substrate so that the treating solution can be supplied to the substrate to clean the substrate.

### CROSS-REFERENCE TO RELATED APPLICATIONS

This U.S. non-provisional patent application claims priority under 35 U.S.C. § 119 to Korean Patent Application No. 10-2007-0106720, filed on Oct. 23, 2007, the entire contents of which are hereby incorporated by reference.

### BACKGROUND

The inventive concept disclosed herein relates to apparatuses and methods for manufacturing integrated circuits, and more particularly, to an apparatus and a method for cleaning a substrate.

Various processes such as a deposition process, a photolithography process and an etching process are used to manufacture a semiconductor device. After each process is finished, a cleaning process is performed to remove unnecessary layers, foreign substances and particles which undesirably remain on a substrate.

Generally, a cleaning process includes a chemical solution treatment process, a rinsing process and a drying process. In the chemical solution treatment process, a chemical solution such as hydrofluoric acid, sulphuric acid and nitric acid is supplied to a substrate to remove foreign substances. In the rinsing process, a cleaning liquid such as deionized water is supplied to the substrate to remove any chemical solution that remains on the substrate. The drying process is a process for removing any of the cleaning liquid that remains on the substrate after the rinsing process.

FIG. 1 shows defects in a gate pattern formed on a substrate. Referring to FIG. 1, when a substrate is treated using a chemical solution, a particle 26 may remain on the substrate. As subsequent layers are deposited on the substrate, defects 28, having a protruded shape on each layer, can occur. Further, a foreign substance 27 may strongly adhere to a substrate, and thus not be removed during a cleaning process. Because a gate pattern is formed by sequentially depositing a number of layers, defects such as these may occur frequently and in a large scale on the layers of the gate pattern. Consequently, such defects can lead to complete failure of devices associated with the gate pattern.

### SUMMARY

An embodiment of the present inventive concept provides an apparatus for cleaning a substrate. The substrate cleaning apparatus comprises a spin head to support a substrate, a first cleaning unit to clean the substrate disposed on the spin head using a polishing process, and a second cleaning unit to clean the substrate disposed on the spin head by injecting a treating solution onto the substrate. The first cleaning unit comprises a support bar and a polishing pad that surrounds an outside of the support bar and is combined with the support bar.

### BRIEF DESCRIPTION OF THE DRAWINGS

The accompanying figures are included to provide a further understanding of the present inventive concept, and are incorporated in and constitute a part of this specification. The drawings illustrate exemplary embodiments of the present inventive concept and, together with the description, serve to explain principles of the present inventive concept. In the figures:

FIG. 1 is a drawing showing defects that are not removed when a conventional cleaning process is performed.

FIG. 2 is a perspective view of a substrate cleaning apparatus in accordance with an embodiment of the present inventive concept.

FIG. 3 is a longitudinal cross section view of the substrate cleaning apparatus of FIG. 2.

FIG. 4 is a top plan view of a substrate cleaning apparatus according to another embodiment of the present inventive concept.

FIGS. 5 and 6 are a longitudinal cross section view and a top plan view of a substrate cleaning apparatus, respectively, according to an embodiment of the present inventive concept.

FIGS. 7 and 8 are a longitudinal cross section view and a top plan view of a substrate cleaning apparatus, respectively, according to an embodiment of the present inventive concept.

FIG. 9 is a drawing showing a substrate including a gate pattern.

FIGS. 10A to 10C illustrate a substrate cleaning process using the substrate cleaning apparatus of FIG. 2.

FIGS. 11A and 11B are longitudinal cross section views of a substrate cleaning apparatus in accordance with other embodiments of the present inventive concept.

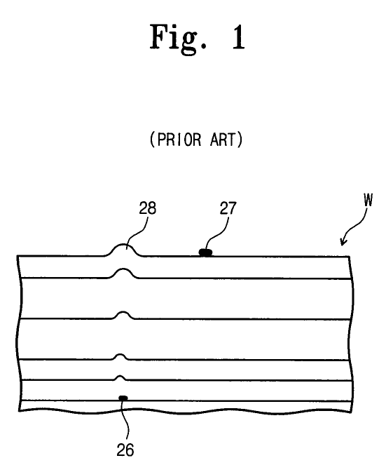

### DETAILED DESCRIPTION OF THE EMBODIMENTS

Preferred embodiments of the present inventive concept will be described below in more detail with reference to the accompanying drawings. The present inventive concept may, however, be embodied in different forms and should not be constructed as limited to the embodiments set forth herein. Rather, these embodiments are provided so that this disclosure will be thorough and complete, and will fully convey the scope of the present inventive concept to those skilled in the art. In the drawings, the thickness of layers and regions are exaggerated for clarity.

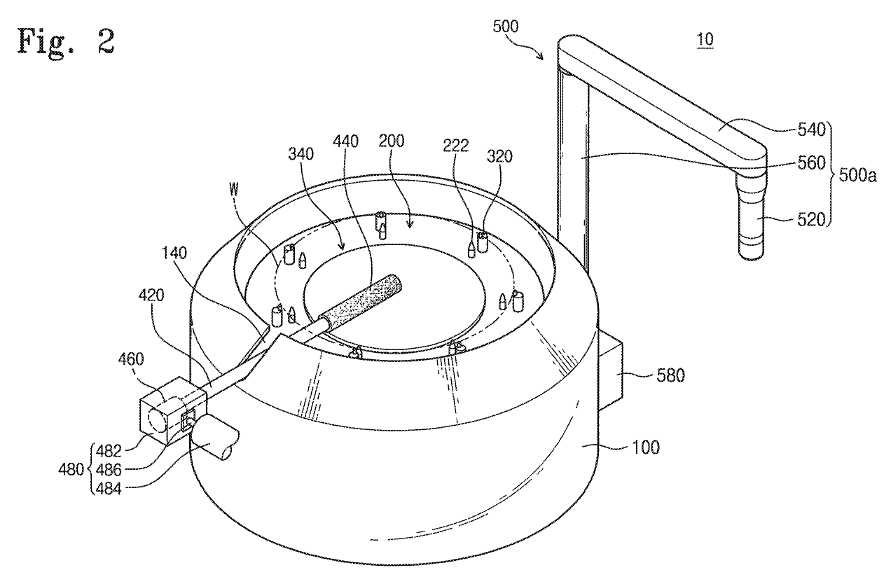

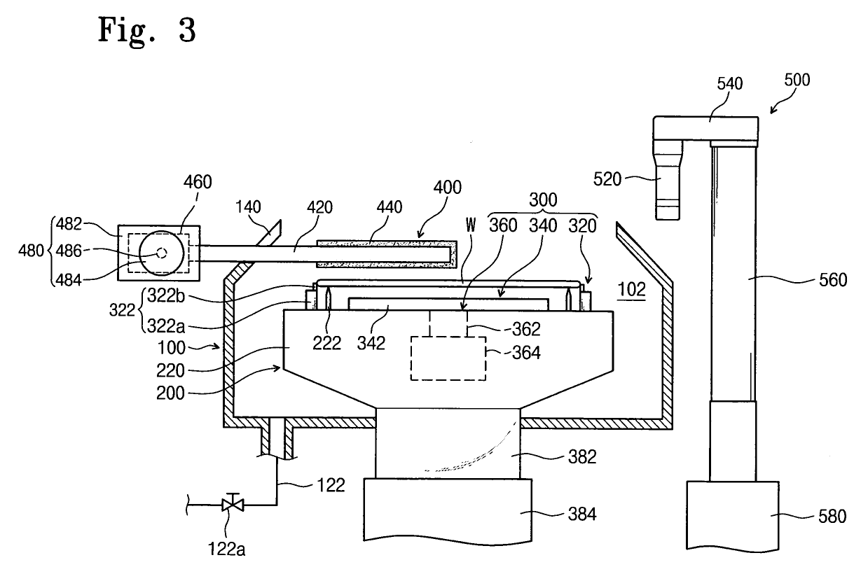

FIG. 2 is a perspective view of a substrate cleaning apparatus in accordance with an embodiment of the present inventive concept and FIG. 3 is a longitudinal cross section view of the substrate cleaning apparatus of FIG. 2.

Referring to FIGS. 2 and 3, a substrate cleaning apparatus 10 includes a vessel 100, a spin head 200, a first cleaning unit 400 and a second cleaning unit 500. The vessel 100 provides a space where a cleaning process is performed. The spin head 200 is disposed in the vessel 100 and supports a wafer (W) during a cleaning process. The first and second cleaning units 400 and 500 remove defects and particles from the wafer (W). The first cleaning unit 400 cleans the wafer (W) by polishing the wafer (W) and the second cleaning unit 500 cleans the wafer (W) by supplying a treating solution to the wafer (W). Hereinafter, each of the elements of the present inventive concept will be described in detail.

The vessel 100 has a space 102 inside of the vessel 100. An upper portion of the space 102 is open. The shape of the vessel 100 prevents a treating solution used in the cleaning process from being splashed outside of the vessel 100. A drain tube 122 is connected to a bottom surface of the vessel 100 to discharge a treating solution used in a cleaning process from the vessel 100 and a valve 122a is installed in the drain tube 122 to close/open the discharge path. A groove 140 having a slit shape is formed on an upper portion of a sidewall of the vessel 100.

The spin head 200 supports the wafer (W) during a cleaning process. The spin head 200 includes a body 220 and a supporting unit 300. A shaft 382, rotated by a driver such as a motor 384, is fixedly combined with a bottom surface of the body 220. The shaft 382 extends downward from the bottom surface of the body 220 outside of the vessel 100. The supporting unit 300 supports the wafer (W) disposed on the body 220. The supporting unit 300 includes a chucking member 320, a vacuum absorbing member 340, and lifting member 360. The wafer (W) is supported on the body 220 by the vacuum absorbing member 340 or the chucking member 320.

The chucking member 320 prevents the wafer (W) from moving in a sideways direction during rotation of the body 220 by contacting a side portion of the wafer (W) disposed on the body 220. The chucking member 320 is used to support the wafer (W) when the wafer (W) rotates at high speed. The chucking member 320 includes chuck pins 322 and a chuck pin driver (not shown). The chuck pins 322 are installed in the body 220 and protrude upwardly from the body 220. Each chuck pin 322 includes a supporting rod 322a and a contact pin 322b. The supporting rod 322a has a cylindrical shape and a lengthwise direction of the supporting rod 322a is perpendicular to a top surface of the body 220. The contact pin 322b protrudes upwardly from an upper end of the supporting rod 322a. A diameter of the contact pin 322b is smaller than a diameter of the supporting rod 322a and a center of the contact pin 322b is eccentric to a center of the supporting rod 322a.

The chuck pin driver (not shown) switches the chuck pins 322 between an opening position and a closing position. When the chuck pins 322 are in the opening position, a space between the contact pins 322b is greater than the wafer (W). When the chuck pins 322 are in the closing position, the contact pins 322b are in contact with a side portion of the wafer (W) disposed between the contact pins 322b. When placing the wafer (W) on the body 220 and lifting the wafer (W) from the body 220, the chuck pins 322 are disposed in the opening position. When the wafer (W) on the body 220 rotates and a process is performed on the wafer (W), the chuck pins 322 are disposed in the closing position. According to an embodiment, the chuck pin driver (not shown) switches the chuck pins 322 between an opening position and a closing position by rotating respective supporting rods 322a. Each of the chuck pins 322 is combined with a shaft (not shown) to which a driven gear is connected and a plurality of the driven gears may interlock to one driving gear, which is rotated. Alternatively, the chuck pins 322 may be provided in a different shape from the example described above. Further, the chuck pin driver (not shown) may switch the chuck pins 322 between the opening position and the closing position by linearly moving the chuck pins 322 in a radial direction of the body 220.

The body 220 includes supporting pins 222 supporting a back side of the wafer (W) while the wafer (W) is supported in a side direction by the chuck pins 322. Each of the supporting pins 222 protrudes upwardly from a top surface of the body 220 and is disposed to support an edge of the back side of the wafer (W). Each of the supporting pins 222 includes an upper portion and a lower portion. The upper portion has a conical shape and is in contact with the back side of the wafer (W). The lower portion has a cylindrical shape and is fixed to the body 220.

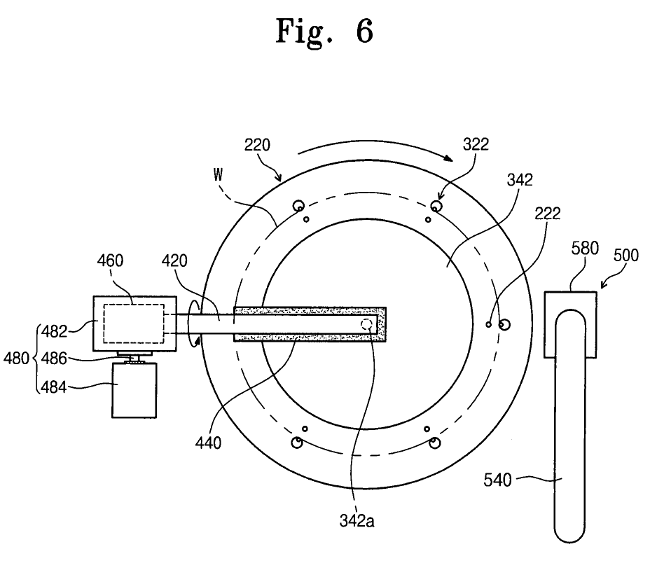

The vacuum absorbing member 340 draws a vacuum on the wafer (W) and fixes the wafer (W) to the body 220. The vacuum absorbing member 340 is used to support the wafer (W) when the wafer (W) rotates at low speed. The vacuum absorbing member 340 includes a vacuum plate 342, a vacuum line (not shown) and a vacuum pump (not shown). The vacuum plate 342 is provided on a top surface of the body 220. The vacuum plate 342 is disposed inside a circle formed by the supporting pins 222. The vacuum plate 342 may have a top surface having a round shape. The vacuum plate 342 includes one or more vacuum holes (for example, vacuum hole 342a of FIG. 6). According to an embodiment, one vacuum hole 342a is provided at a center of the vacuum plate 342. Alternatively, a plurality of the vacuum holes 342a may be disposed in the vacuum plate 342 so as to form a ring shape. The vacuum line is connected to the vacuum holes 342a and the vacuum pump is installed in the vacuum line.

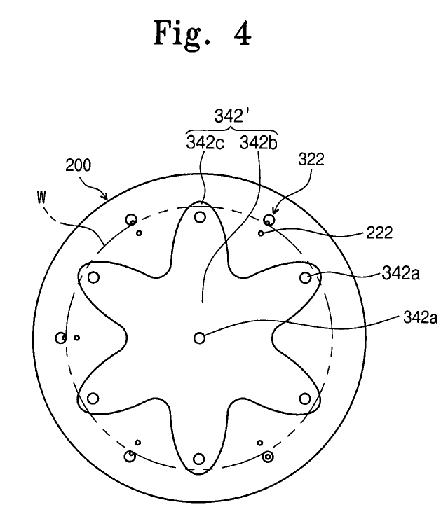

The vacuum plate 342 may have various shapes. For instance, as shown in FIG. 4, a vacuum plate 342′ includes an inside region 342b having a round shape and outside regions 342c that extend outwardly from the inside region 342b so as to have a protruded shape. The outside regions 342c are disposed around the inside region 342b at regular intervals and about six outside regions 342c may be provided. The number of outside regions 342c may change according to the desired application. The chuck pins 322 and the supporting pins 222 may be disposed on the body 220 between adjacent outside regions 342c. The vacuum holes 342a may be provided on respective outside regions 342c of the vacuum plate 342. The vacuum hole 342a may be additionally provided on the central region 342b of the vacuum plate 342.

The lifting member 360 changes a relative height between the vacuum absorbing member 340 and the chucking member 320. When the wafer (W) is supported by the chucking member 320, the chucking member 320 is disposed higher than the vacuum absorbing member 340. When the wafer (W) is supported by the vacuum absorbing member 340, the vacuum absorbing member 340 is disposed higher than the chucking member 320. According to an embodiment, the lifting member 360 moves the vacuum absorbing member 340 up and down. The lifting member 360 is installed in the body 220 so that the lifting member 360 can rotate together with the body 220. The lifting member 360 includes a lifting axis 362 and a vertical driver 364. The lifting axis 362 extends downward from a lower end of the vacuum plate 342 and the vertical driver 364 is connected to the lifting axis 362. A hydraulic or pneumatic cylinder or a motor may be used as the vertical driver 364. As an alternative to that described above, the lifting member 360 may move the chuck pins 322 and the supporting pins 222 up and down, rather than the vacuum absorbing member 340.

A first cleaning unit 400 cleans the wafer (W) using a polishing process. According to an embodiment, the first cleaning unit 400 cleans the wafer (W) using a chemical mechanical polishing (CMP) process. The first cleaning unit 400 includes a support bar 420, a polishing pad 440, a rotating member 460 and a bar moving member 480. The support bar 420 has a long rod shape which extends in one direction. The support bar 420 has a length that is greater than a radius of the wafer (W). The support bar 420 may have a round cross sectional shape when the support bar 420 is cut along a direction that is perpendicular to its lengthwise direction. The polishing pad 440 surrounds an outside and an end of a portion of the support bar 420 and is fixedly combined with the support bar 420. The polishing pad 440 may have a roller shape such that a hole is formed in a center of the polishing pad 440 where the support bar 420 is inserted. The polishing pad 440 has a length that is equal to or greater than a radius of the wafer (W). The polishing pad 440 can be formed of a material including an abrasive. The wafer (W) is chemically polished by the abrasive and is mechanically polished by friction with the polishing pad 440. Various abrasives can be used according to the type of layer on the wafer (W). Alternatively, an abrasive may not be included in the polishing pad 440 and may be instead provided to the wafer W through a separate nozzle 520.

The rotating member 460 rotates using an axis of a lengthwise direction of the support bar 420 as a rotation axis. This places an entire region of the polishing pad 440 sequentially in contact with the wafer (W) when the polishing pad 440 is in contact with the wafer (W) and the rotating member 460 is rotating the support bar 420. A motor having a shaft connected to the end of the support bar 420 can be used as the rotating member 460.

The bar moving member 480 moves the support bar 420 so that the polishing pad 440 switches between a contact position and a standby position. In the contact position, the polishing pad 440 is in contact with a top surface of the wafer (W) disposed on the spin head 200. In the standby position, the polishing pad 440 is not in contact with a top surface of the wafer (W) disposed on the spin head 200. The polishing pad 440 contacts an upper portion of the wafer (W) so as to be parallel with a top surface of the wafer (W). In the standby position, the polishing pad 440 is disposed away from the upper portion of the wafer (W). According to the present embodiment, the bar moving member 480 rotates the support bar 420, thereby moving the support bar 420 between the contact position and the standby position. In the standby position, the support bar 420 may be disposed such that a length of the support bar 420 is oriented in a vertical direction and is disposed outside of the vessel 100. The bar moving member 480 includes a bracket 482 and a motor 484. The bracket 482 is fixedly combined with the rotating member 460. The bracket 482 is also fixedly combined with the shaft 486 connected to the motor 484.

As an alternative, a hole (not shown) can be formed in a sidewall of the vessel 100 and the bar moving member 480 can linearly move the support bar 420 in a horizontal direction through the hole, thereby moving the polishing pad 440 between the contact position and the standby position.

As another alternative, the bar moving member 480 may be configured to linearly move the support bar 420 up and down. In this case, the standby position is a position that is sufficiently spaced apart upwardly from the top surface of the wafer (W) so as not to interfere with the second cleaning unit 500 when the wafer (W) moves and a cleaning process is performed on the wafer (W).

The second cleaning unit 500 cleans the wafer (W) using a process of injecting a treating solution on the wafer (W). The second cleaning unit 500 includes a treating solution supplying member and a drying gas supplying member (not shown). The treating solution supplying member includes a chemical solution supplying member 500a and a rinsing liquid supplying member (not shown). The chemical solution supplying member 500a supplies the wafer (W) with a chemical solution such as hydrofluoric acid, sulphuric acid, nitric acid or ammonium hydroxide to remove foreign substances from the wafer (W). The rinsing liquid supplying member supplies the wafer (W) with a rinsing liquid such as deionized water to remove foreign substances or any chemical solution that remains on the wafer (W). The drying gas supplying member supplies the wafer (W) with an alcohol such as isopropyl alcohol or an inert gas such as a heated nitrogen gas to remove any rinsing liquid that remains on the wafer (W).

The chemical solution supplying member 500a includes a nozzle 520, a supporting rod 540, and a vertical rod 560. The vertical rod 560 is located outside of the vessel 100. The vertical rod 560 is combined with a driver 580 that rotates the vertical rod 560 and moves the vertical rod 560 up and down. The supporting rod 540 is disposed in a direction that is perpendicular to the vertical rod 560 and is fixedly combined with an upper end of the vertical rod 560. The nozzle 520 protrudes downwardly from the supporting rod 540 and is fixedly combined with the bottom of the supporting rod 540. A drain tube for discharging a chemical solution is provided at the nozzle 520. When a process is performed using a chemical solution, the nozzle 520 of the chemical solution supplying member 500a is disposed inside of the vessel 100 or over the vessel 100 so as to supply a chemical solution to the wafer (W). The nozzle 520 is in standby outside of the vessel 100 at times other than when a process is being performed using the chemical solution. The rinsing liquid supplying member and the drying gas supplying member have a structure similar to that of the chemical solution supplying member 500a.

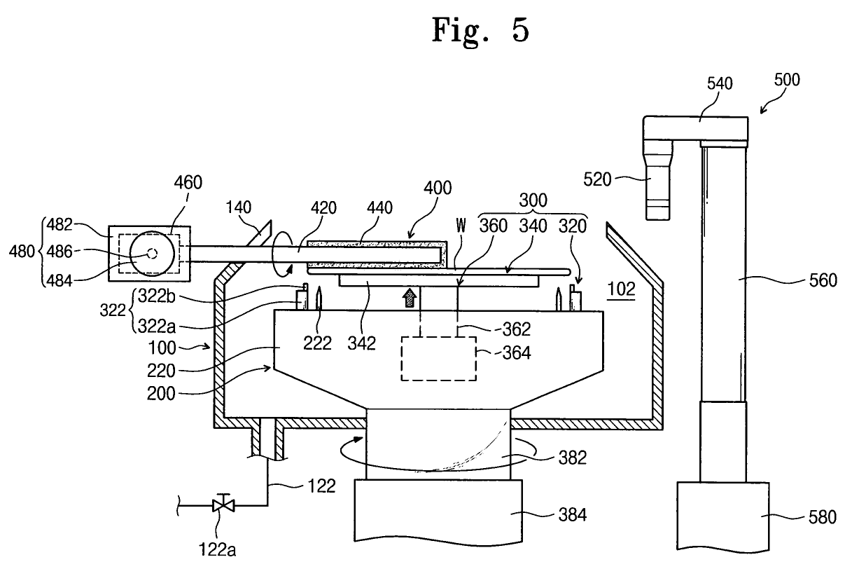

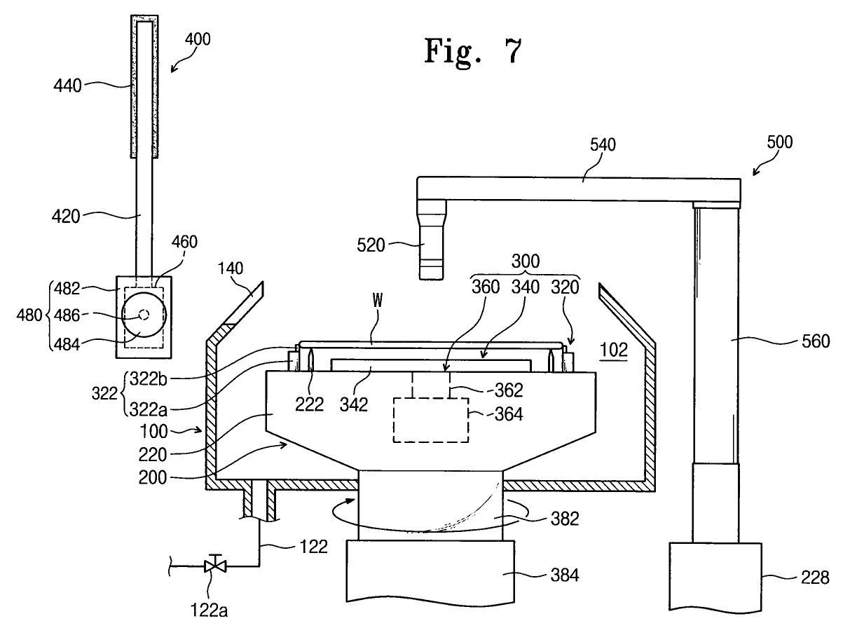

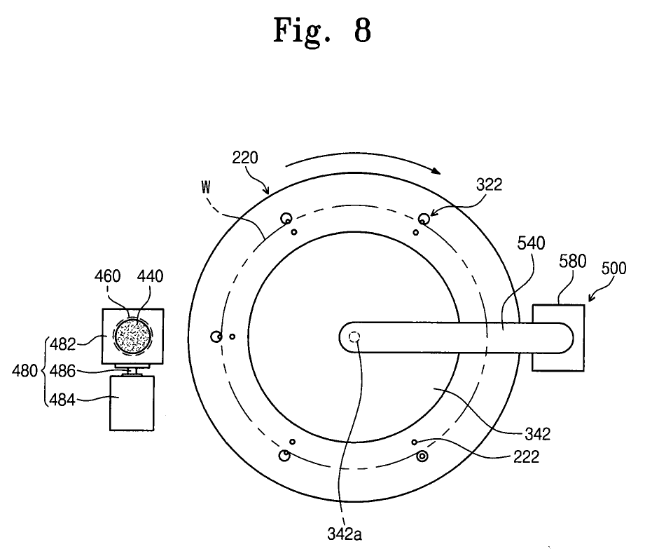

FIGS. 5 to 8 show a state in which the wafer (W) is being cleaned by the first cleaning unit 400 and the second cleaning unit 500. FIGS. 5 and 6 are a longitudinal cross section view and a top plan view of a substrate cleaning apparatus, respectively, showing the wafer (W) being cleaned by the first cleaning unit 400. FIGS. 7 and 8 are a longitudinal cross section view and a top plan view of a substrate cleaning apparatus, respectively, showing the wafer (W) being cleaned by the second cleaning unit 500.

Referring to FIGS. 5 and 6, while a cleaning is being performed by the first cleaning unit 400, the polishing pad 440 is disposed in parallel with a surface of the wafer (W) and in contact with the surface of the wafer (W). When the wafer (W) is supported by the chuck pins 322 and the spin head 200 rotates, interference could occur between the chuck pins 322 and the support bar 420. Thus, while the wafer (W) is cleaned by the first cleaning unit 400, the wafer (W) is fixed to the spin head 200 by the vacuum absorbing member 340. The lifting member 360 lifts the vacuum plate 342 so that the vacuum plate 342 is disposed higher than the chuck pins 322 and drives the vacuum pump so that the wafer W is securely held to the vacuum plate 342. The support bar 420 moves from the standby position to the contact position such that the polishing pad 440 is in contact with a surface of the wafer (W). The wafer (W) rotates using the central axis of the wafer as a rotation axis and the polishing pad 440 rotates using the central axis of the support bar 420 as a rotation axis. The cleaning by the first cleaning unit 400 is performed for a predetermined time.

Referring to FIGS. 7 and 8, while cleaning is performed by the second cleaning unit 500, the nozzle 520 is disposed so that a treating solution is supplied to the wafer (W). The treating solution can be supplied to a center of the wafer (W) or the treating solution can be supplied to other parts of the wafer (W), for instance, in a sweeping motion of the nozzle 520. The wafer (W) rotates and the treating solution spreads from the center toward an edge of the wafer (W). The wafer (W) rotates at high speed so that the treating solution uniformly spreads to an entire surface of the wafer (W). If the wafer (W) is fixed to the spin head 200 by vacuum only, the wafer (W) could move in a side direction while the wafer (W) rotates at high speed. Thus, a side surface of the wafer (W) can be supported by the chuck pins 322 during a cleaning process by the second cleaning unit 500.

A rotation speed of the wafer (W) when the wafer (W) is supported by the vacuum plate 342 may be lower than a rotation speed of the wafer (W) when the wafer (W) is supported by the chuck pins 322.

Following is a description of a process using the substrate cleaning apparatus 10 described above. Initially, the vacuum plate 342 is disposed lower than the chuck pins 322. The chuck pins 322 are disposed in the opening position. The first and second cleaning units 400 and 500 are disposed outside of the vessel 100. The wafer (W) is transferred by a transferring robot and placed on the supporting pins 222. The chuck pins 322 move to the closing position and the wafer (W) is aligned accordingly.

The wafer (W) is then cleaned by means of a polishing process using the first cleaning unit 400. The first cleaning unit 400 can remove portions of a top layer that are protruded upwardly from a surface of the wafer (W). The portions protruded upwardly from the surface of the wafer (W) may be a foreign substance that adheres on the surface of the wafer (W) or a defect that is formed as a protruding shape due to subsequent depositions on a layer having a particle adhered thereto. Alternatively, the entire surface of the wafer (W) can be polished using the first cleaning unit 400 to reduce the thickness by about 10 to 100 angstroms.

Before the polishing process is performed by the first cleaning unit 400, the chuck pins 322 move to the opening position, the vacuum plate 342 goes up to secure the wafer and the support bar 420 moves from the standby position to the contact position. A top surface of the wafer (W) is polished by rotation of the wafer (W) and the support bar 420.

The polishing process is completed by the first cleaning unit 400 and then a cleaning by the second cleaning unit 500 begins. The vacuum plate 342 goes down to place the wafer (W) on the supporting pins 222. The chuck pins 322 move to the closing position and support the substrate. The support bar 420 moves from the contact position to the standby position and the chemical solution supplying member 500a moves so that the nozzle 520 is disposed above the center of the wafer (W). A side portion of the wafer (W) is supported by the chuck pins 322 during the cleaning process by the second cleaning unit 500.

The nozzle 520 injects cleaning liquid onto the wafer (W) and the wafer (W) rotates at high speed. When a predetermined time elapses, rinsing liquid and drying gas are sequentially injected to the center of the wafer (W) and the wafer (W) continues to rotate.

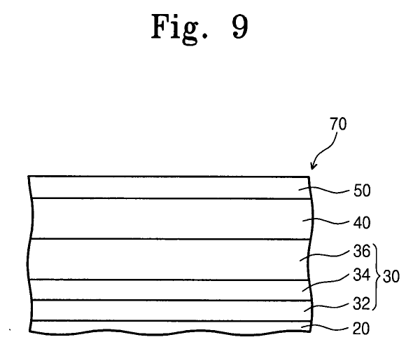

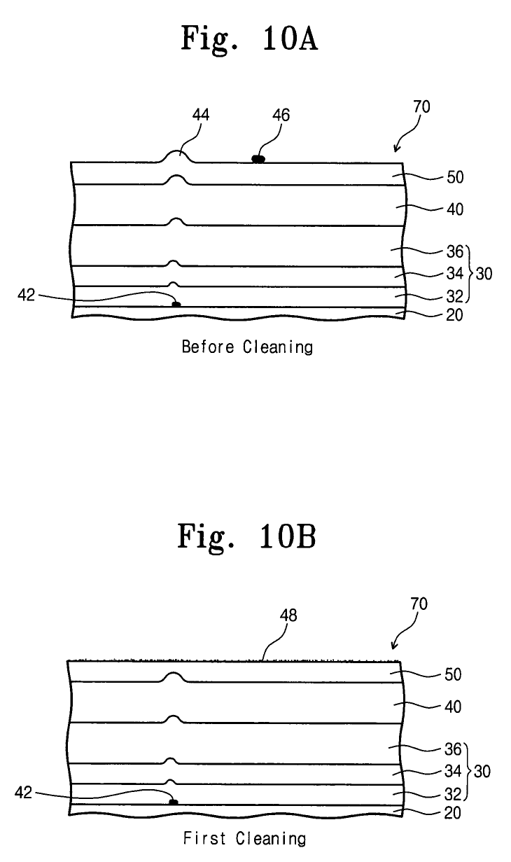

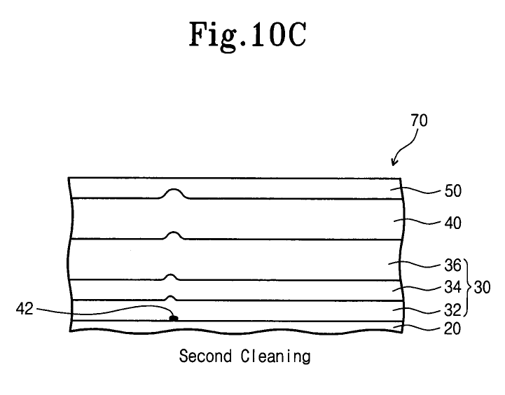

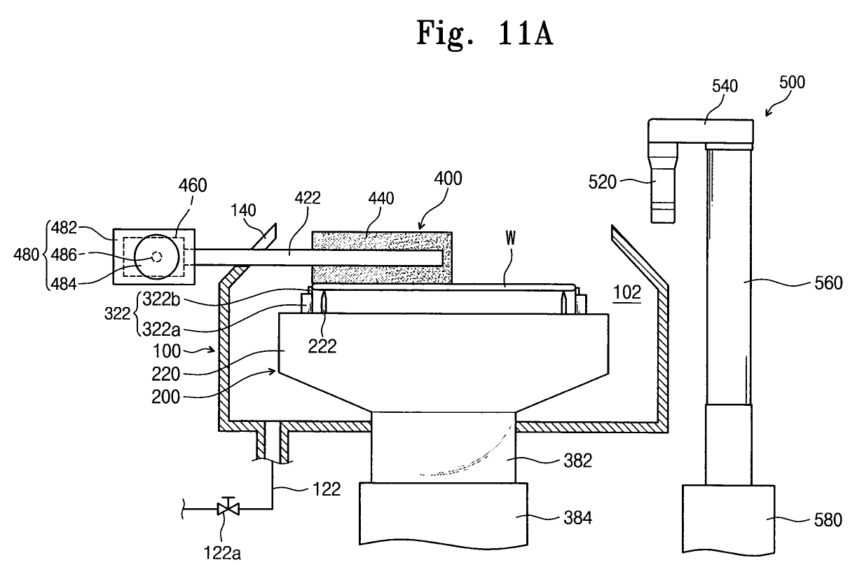

Referring to FIGS. 9 and 10A through 10C, a process of removing an unwanted protrusion 44 on the wafer (W) using the apparatus 10 of the present inventive concept will be described. A thin film on which cleaning is performed may be a thin film for forming various kinds of patterns on a wafer (W). The unwanted protrusion 44 is formed when subsequent thin films are deposited on the wafer (W) on top of layers containing foreign substances and/or particles. The higher the number of thin films deposited on the wafer (W) containing the foreign substances and/or particles, the larger the size of the protrusion formed on the uppermost thin film. Various patterns are formed on the wafer (W), and more particularly, a gate pattern 70 is formed to include a number of the thin films. As shown in FIG. 9, the gate pattern 70 is formed by depositing several tens of thin films in order to form a gate insulating layer 20, a gate conductive layer 30, a capping layer 40 and a reflection preventing layer 50 on the wafer (W). The gate insulating layer 20 is formed of an oxide layer. The gate conductive layer 30 is formed of a metal barrier layer 34 such as a polysilicon layer 32 and a titanium nitride layer, and a metal layer 36 such as tungsten. The capping layer 40 is formed of a nitride layer such as silicon nitride and the reflection preventing layer 50 is formed of an oxynitride such as silicon oxynitride.

FIGS. 10A to 10C show a process by which an upper layer 50 including a protrusion 44 is cleaned using the apparatus 10 of the present inventive concept. As shown in FIG. 10A, several thin films (i.e., layers 34, 36, 40 and 50) are deposited on the lower layer 20, including a foreign substance 42. Initially, as shown in FIG. 10A, the protrusion 44 and/or a foreign substance 46 are present on the upper layer 50. Once a polishing process is performed using the first cleaning unit 400, as shown in FIG. 10B, the protrusion 44 and the foreign substance 46 are removed. However, a portion of the particles 48 generated from the polishing process remain on a surface of the upper layer 50. Once a cleaning process is performed using the second cleaning unit 500, as shown in FIG. 10C, the particles on the surface of the upper layer 50 are removed. Hence, by using the first cleaning unit 400 and the second cleaning unit 500, protrusions and foreign substances can be effectively removed from the upper layer 50.

A cleaning process as described above may be performed during the process of cleaning the uppermost layer after forming the gate pattern 70. For instance, the cleaning process may be performed during the process of cleaning the reflection preventing layer 50. Alternatively, the cleaning process may be performed during the process of cleaning any layer deposited on the wafer (W) to form the gate pattern 70 or during the process of cleaning each layer of the gate pattern 70. The cleaning process may also be performed during the process of cleaning a thin film deposited on the wafer (W) to form different kinds of patterns besides the gate pattern 70.

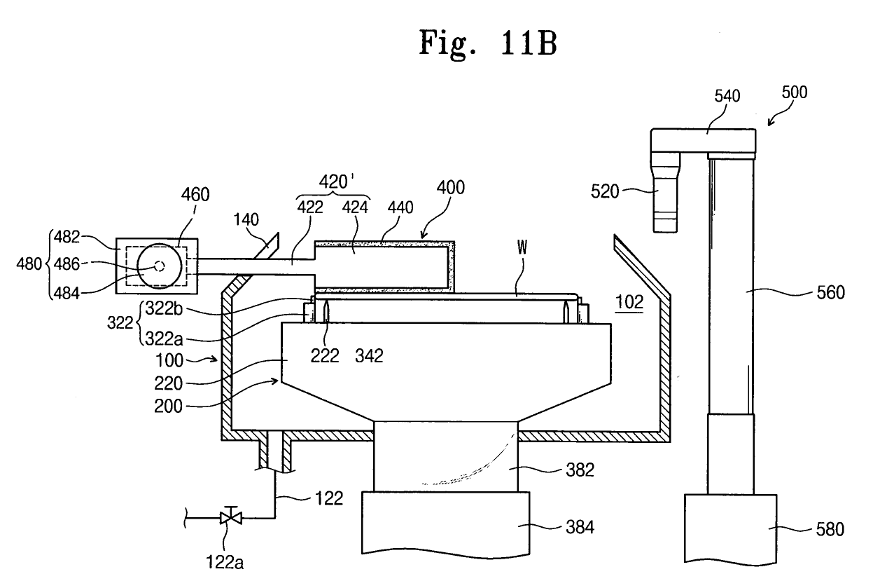

FIGS. 11A and 11B show another embodiment of the cleaning apparatus 10 of the present inventive concept. The cleaning apparatus 10 of FIGS. 11A and 11B has a structure similar to the cleaning apparatus 10 of FIG. 2. The supporting unit 300 of the cleaning apparatus 10 of FIG. 2 includes the vacuum absorbing member 340 and the chucking member 320 while the cleaning apparatus 10 of FIGS. 11A and 11B includes only the chucking member 320 without the vacuum absorbing member 340 and so the wafer (W) is supported by the chucking member 320 during a cleaning process by both the first and second cleaning units 400 and 500.

Interference between the polishing pad 440 and the chuck pins 322 should be prevented during a cleaning process by the first cleaning unit 400. Accordingly, a distance between a central axis of the support bar 420 and an external surface of the polishing pad 440 is provided so that the external surface of the polishing pad 440 is in contact with the substrate when the support bar 420 is disposed higher than the chuck pins 322.

According to an embodiment, as shown in FIG. 11A, a thickness of the polishing pad 440 is relatively thick. When the support bar 420 is disposed over the chuck pins 322, the polishing pad 440 has a thickness such that an external surface of the polishing pad 440 is in contact with a surface of the wafer (W) but not in contact with the chuck pins 322.

According to another embodiment, as shown in FIG. 11B, when a support bar 420′ is disposed in the contact position, a part 424 of the support bar 420′ facing the wafer (W) has a diameter greater than the other part 422 of the support bar 420′ and the polishing pad 440 surrounds only the part 424 of the support bar 420′ having a larger diameter.

The body 220 may rotate at the same speed during a process of cleaning the wafer (W) by both the first and second cleaning units 400 and 500. Alternatively, when the wafer (W) is cleaned by the first cleaning unit 400, the wafer (W) may rotate at a low speed as compared with when the wafer (W) is cleaned by the second cleaning unit 500.

In the embodiment described above, the cleaning process is performed in one vessel. But, alternatively, the cleaning by the first cleaning unit 400 and the cleaning by the second cleaning unit 500 can be performed in different vessels, and the substrate may move to a vessel serviced by the second cleaning unit 500 after a cleaning process utilizing the first cleaning unit 400.

Although the present inventive concept has been described in connection with the embodiments of the present inventive concept illustrated in the accompanying drawings, it is not limited thereto. It will be apparent to those skilled in the art that various substitutions, modifications and changes may be made thereto without departing from the scope and spirit of the inventive concept.

What is claimed is:

1. A substrate cleaning apparatus, comprising:
a spin head configured to support a substrate;
a first cleaning unit configured to clean the substrate using a polishing process; and
a second cleaning unit configured to clean the substrate by injecting a treating solution onto the substrate,
wherein the first cleaning unit comprises:
a support bar; and
a polishing pad substantially surrounding an outside portion of the support bar.

2. The apparatus of claim 1, wherein the first cleaning unit further comprises a rotating member configured to rotate the support bar about a longitudinal axis of the support bar during the polishing process.

3. The apparatus of claim 1, further comprising a moving member configured to move the support bar between a contact position in which the polishing pad is in contact with a top surface of the substrate and a standby position in which the polishing pad is not in contact with a top surface of the substrate.

4. The apparatus of claim 3, further comprising a vessel that substantially surrounds the spin head and includes:
an open upper portion; and
a groove disposed on an upper end of the vessel such that the support bar transfers from the standby position to the contact position through the groove.

5. The apparatus of claim 1, wherein the spin head comprises:
a body configured to rotate; and
a supporting unit configured to hold the substrate to the body during rotation of the body, wherein the supporting unit includes:
a vacuum absorbing member; and
chuck pins configured to support a side portion of the substrate during the rotation.

6. The apparatus of claim 5, wherein the supporting unit further comprises a lifting member configured to move at least one of the chuck pins and the vacuum absorbing member up and down in order to change a relative height between the vacuum absorbing member and the chuck pins.

7. The apparatus of claim 1, wherein the spin head comprises:
a body configured to rotate; and
chuck pins configured to switch between an opening position and a closing position, wherein:
the opening position provides sufficient space for the substrate to be placed on the body;
the chuck pins contact a side portion of the substrate in the closing position and support the substrate during rotation of the substrate; and
a distance between a central axis of the support bar and an external surface of the polishing pad is configured so that the external surface of the polishing pad contacts the substrate without contacting the chuck pins.

8. The apparatus of claim 1, wherein a length of the polishing pad is equal to or greater than a radius of the substrate.

9. The apparatus of claim 1, wherein the polishing pad comprises an abrasive material.

10. A substrate cleaning apparatus, comprising:
a vessel;
a spin head configured to support a substrate in the vessel;
a first cleaning unit configured to polish the substrate; and
a second cleaning unit configured to clean the substrate;
wherein the first cleaning unit comprises:
a support bar; and
a polishing pad disposed on a longitudinal portion of the support bar.

11. The apparatus of claim 10, wherein the first cleaning unit further comprises a support bar moving member configured to move the support bar between a contact position and a standby position.

12. The apparatus of claim 11, wherein the support bar moving member is further configured to rotate the support bar about a longitudinal axis of the support bar.

13. The apparatus of claim 11, wherein the vessel comprises a groove and wherein the support bar penetrates the groove when the support bar is in the contact position.

14. The apparatus of claim 10, wherein the spin head comprises:
a plurality of supporting pins configured to support a surface of the substrate; and
a plurality of chuck pins configured to support sides of the substrate.

15. The apparatus of claim 14, wherein the spin head further comprises a vacuum plate and wherein the spin head is configured to lift at least one of the vacuum plate and the supporting pins so that the substrate is supported on either the vacuum plate or the supporting pins.

16. The apparatus of claim 15, wherein the vacuum plate comprises a vacuum hole disposed at a center of the vacuum plate.

17. The apparatus of claim 15, wherein the vacuum plate comprises:
an inside region having a round shape; and
at least one outside region extending from the inside region, wherein each of the outside regions includes a vacuum hole.

18. The apparatus of claim 15, wherein the vacuum plate is configured to hold the substrate in a raised position during a polishing process with the first cleaning unit and wherein the vacuum plate is configured to be in a lowered position during a cleaning process with the second cleaning unit.

19. The apparatus of claim 14, wherein the supporting pins and the chuck pins are configured to support the substrate during a polishing process with the first cleaning unit and during a cleaning process with the second cleaning unit.

20. The apparatus of claim 10, wherein the second cleaning unit comprises:
a vertical rod disposed outside of the vessel;
a supporting rod extending substantially perpendicularly from the vertical rod; and
a nozzle extending downwardly from the supporting rod, the nozzle configured to spray at least one of a treating solution and a drying gas on the substrate.

21. The apparatus of claim 20, wherein the vertical rod is configured to rotate and to move up and down such that the nozzle can be moved into the vessel for cleaning the substrate and out of the vessel when the substrate is not being cleaned.

22. The apparatus of claim 10, wherein the support bar comprises:
a first portion having a first width; and
a second portion having a second width, wherein the second width is larger than the first width and wherein the second portion includes the longitudinal portion.

23. A substrate cleaning apparatus, comprising:
a vessel;
a spin head configured to support a substrate in the vessel and to rotate the substrate;
a first cleaning unit including:
a support bar;
a polishing pad disposed on a longitudinal portion of the support bar;
a rotating member configured to rotate the support bar about a longitudinal axis of the support bar; and
a bar moving member configured to move the support bar between a contact position in the vessel and a standby position outside of the vessel; and
a second cleaning unit including:
a vertical rod disposed outside of the vessel;
a supporting rod extending outwardly from the vertical rod;
a nozzle extending downwardly from the supporting rod; and
a driver configured to rotate the vertical rod and to move the vertical rod up and down.

24. The substrate cleaning apparatus of claim 23, wherein the vessel further comprises a groove disposed in an upper portion thereof and wherein the support bar penetrates the groove when in the contact position.

25. The apparatus of claim 23, wherein the spin head comprises:
a plurality of supporting pins configured to support a surface of the substrate; and
a plurality of chuck pins configured to support sides of the substrate.

26. The apparatus of claim 25, wherein the spin head further comprises a vacuum plate and wherein the spin head is configured to lift at least one of the vacuum plate and the supporting pins so that the substrate is supported on either the vacuum plate or the supporting pins.
